(19) United States
(12) Patent Application Publication
(10) Pub. No.: US 2015/0310452 A1
(43) Pub. Date: Oct. 29, 2015

(54) Access Control System For Medical And Dental Computer Systems

(71) Applicant: AuthAir, Inc., Woodbridge, CT (US)

(72) Inventors: Yaron Baitch, Woodbridge, CT (US); Mohammad Etesam, Hamden, CT (US); Nicholas Bereza, Wethersfield, CT (US)

(73) Assignee: AuthAir, Inc., Woodbridge, CT (US)

(21) Appl. No.: 14/332,364

(22) Filed: Jul. 15, 2014

Related U.S. Application Data
(60) Provisional application No. 61/984,815, filed on Apr. 27, 2014.

(51) Int. Cl. G06Q 30/00; G06Q 50/22; G06F 21/35

(52) U.S. Cl. CPC G06Q 30/018; G06F 21/35; G06Q 50/22

(57) ABSTRACT

An access control system for medical and dental computer systems includes at least one computer workstation communicating with a wireless channel that executes at least one wireless protocol that allows communication with and identification of at least one wireless-enabled token through the wireless channel and that controls a predetermined level of system access to the computer workstation for an authorized individual in possession of the token. A wireless-enabled token uniquely identifies an authorized individual wherein the computer workstation is unlocked when the wireless-enabled token resides within the proximity zone and the computer workstation is locked when the wireless-enabled token resides outside the proximity zone.

### CROSS-REFERENCE TO RELATED APPLICATION

This application is a non-provisional application of U.S. Provisional Patent Application Ser. No. 61/984,815 filed Apr. 27, 2014, entitled “Access Control System for Medical and Dental Computer Systems.” The entire disclosure of U.S. Provisional Patent Application Ser. No. 61/984,815 is incorporated herein by reference.

The section headings used herein are for organizational purposes only and should not to be construed as limiting the subject matter described in the present application in any way.

### INTRODUCTION

Protecting the security and privacy of medical and dental patient records is a growing challenge for health care providers. Government regulations increasingly require mandatory use of electronic records together with stiff penalties enforcing the protection of the privacy of those records. For example, the Office for Civil Rights enforces the Health Insurance Portability Accountability Act (HIPAA) Privacy Rule, which was enacted to protect the privacy of individuals' health information. The HIPAA Security Rule sets national standards for the security of electronic protected health information, and the HIPAA Breach Notification Rule requires notification following a breach of protected health information. These regulations require more reliance on computer hardware and software information technology for patient record keeping. In addition, these regulations require information technology systems that ensure authentication and authorization of the individuals accessing those systems. These regulations require an audit system to provide a record of who, when, and what private information is accessed.

Computer security systems being used today in medical and dental offices are generally complex and cumbersome. The systems were designed for general computer security applications and are not designed specifically for the specialized medical and dental office environments. In particular, these computer systems do not accommodate information technology usage patterns and patient practices particular to the medical and dental office practice. Also, these systems do not particularly address issues of government compliance, including those rules detailed in HIPAA.

Modern computer security systems typically require a user to physically log into a computer using a keyboard to authenticate and authorize user access. The user must remember a code for login. Modern computer security systems are not automated and do not require that the user remember to both open and close the system for access. For example, computer security systems for medical and dental offices do not accommodate all the operative, front office, and back office needs of a medical and dental office environment. Furthermore, modern computer security systems for medical and dental offices are not simple to integrate into existing information systems, and are not scalable as the medical or dental practice grows and expands.

### BRIEF DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. In the drawings, like reference characters generally refer to like features and structural elements throughout the various figures. The drawings are not intended to limit the scope of the Applicants' teaching in any way.

FIG. 1A illustrates a medical and dental office secured workstation, authorized individual, and wireless-enabled token within a proximity zone.

FIG. 1B illustrates a medical and dental office secured workstation, authorized individual, and wireless-enabled token outside a proximity zone.

FIG. 2 illustrates an embodiment of an administrative user computer dashboard according to the present teaching.

FIG. 3 illustrates an embodiment of a management console computer interface according to the present teaching.

FIG. 4 illustrates an embodiment of a dongle control board according to the present teaching.

FIG. 5 illustrates an embodiment of a token that can be attached to a belt according to the present teaching.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings may be performed in any order and/or simultaneously as long as the teaching remains operable. Furthermore, it should be understood that the apparatus and methods of the present teachings can include any number or all of the described embodiments as long as the teaching remains operable.

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

The present teaching relates to access control for medical and dental office computer systems. The medical and dental office computer systems according to the present teaching include features that replace the traditional keyboard-entry, password and/or code based login capabilities that modern operating systems use to provide authentication and authorization for unlocking and limiting system access to hardware and software. One feature of the computer security system of the present teaching replaces traditional password and/or code based keyboard entry with a wireless-enabled token that may be secured or unsecured, and that uniquely identifies an authorized individual and automatically provides the appropriate level of access for that authorized individual on a particular medical and dental office workstation in close proximity to the token. The dental office computer system of the present teaching also locks a workstation when the wireless-enabled token associated with an authorized individual is not in a defined proximity zone of the workstation. “Proximity zone,” as used herein, defines the region around the workstation where token wireless communication with the workstation causes the workstation to unlock. The workstation remains unlocked for the full duration of the period in which the token is within the proximity zone. When the token is moved across the boundary of the proximity zone to a region outside of the proximity zone, the workstation locks.

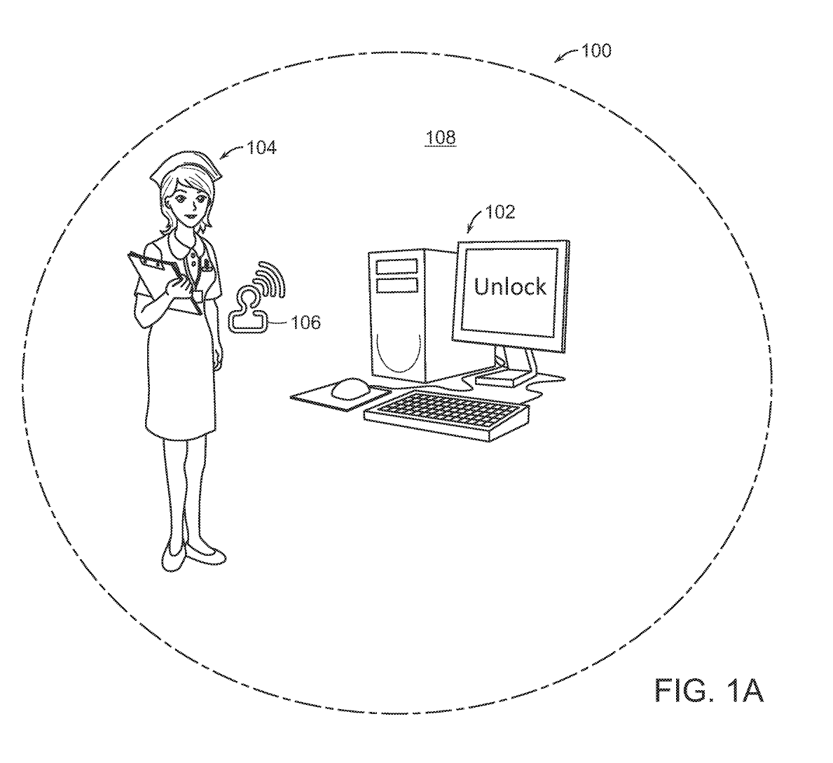

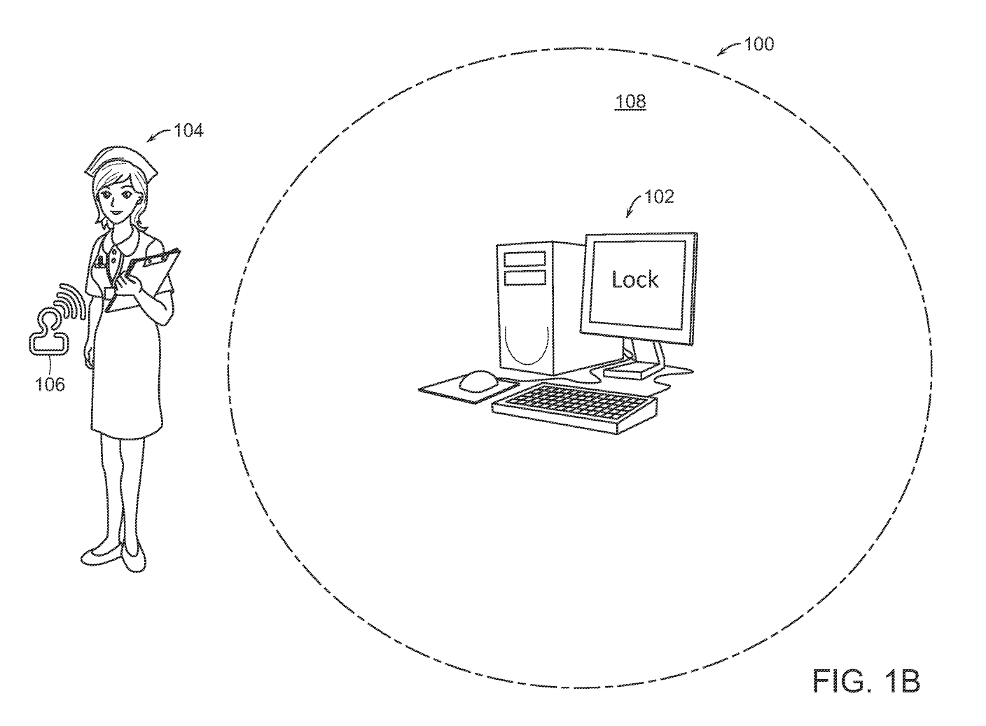

The system 100 and method shown in FIG. 1 provides access control to a computer workstation 102 and the associated workstation applications and stored data for medical and dental practices. Thus, the system and method of the present teaching provides a predetermined level of system access to the workstation, which means providing access to predetermined medical and/or dental records, and/or predetermined computer applications, and/or predetermined stored data, and/or predetermined computer system administration functions. The specific predetermined accesses listed herein are exemplary and not intended to limit the teaching in any way. The term “workstation,” as used herein, refers to any one of numerous computing devices, including those that are desktop, portable, laptop, handheld, and wearable. FIG. 1A illustrates a medical or dental office secured workstation 102, authorized individual 104, and wireless-enabled token 106 within a proximity zone. FIG. 1B illustrates a medical and dental office workstation 102, authorized individual 104, and wireless-enabled token 106 outside a proximity zone. More generally, FIG. 1A and FIG. 1B illustrate an embodiment of the system 100, according to the present teaching, that includes one or more workstations 102, one or more medical and dental office workers 104, and one or more associated tokens 106. Only one workstation 102, medical and dental office worker 104, and token 106 are shown in FIG. 1A and FIG. 1B. However, one skilled in the art will appreciate that the any number of medical and dental workers can be accommodated by the methods and apparatus of the present teaching.

In one embodiment of the present teaching, one or more wireless-enabled tokens 106 automatically lock and unlock the one or more workstations 102 that are secured by the medical and dental office computer security system 100. The wireless-enabled tokens 106 can take numerous forms, including a dedicated token device, such as a key fob, or a multi-function device, such a cell phone or other portable wireless device. FIG. 1A illustrates that the wireless-enabled tokens 106 cause the workstation 102 to automatically unlock when the tokens 106 enter into a region 108 that is within the proximity zone of the workstation 102. FIG. 1B illustrates that as the wireless-enabled tokens 106 leave the region 108 within the proximity zone of the workstation 102, the workstation automatically locks. The workstation cannot be accessed by unauthorized persons, including patients or visitors, when the workstation is locked. The authorized office workers 104 may include any type of medical and/or dental professional, office assistant, or other administrators.

In many practical applications, the authorized medical and dental office workers 104 carry the tokens 106. The tokens 106 uniquely identify the individual associated with the token 106. When an authorized office worker 104 wearing or carrying a token 106 enters a region 108 within the proximity zone of the workstation, the workstation 102 automatically unlocks, and the authorized individual is able to access the applications and information associated with the workstation 102.

The applications and information associated with the workstation 102 may include practice management software and patient record databases. The applications and information associated with the workstation 102 may also include computer system security software, including management administration functions and audit capability. The authorized individual does not need to enter login information to access the applications and information associated with the workstation 102.

In some embodiments, the automatic unlock function executes in a time of between 2-3 seconds after the wireless-enabled token 106 enters the proximity region 108 of the workstation 102. In some embodiments, the automatic lock function executes in a time of between 5-7 seconds after a wireless-enabled token 106 leaves the region 108 of the workstation 102. In some embodiments of the present teaching, the size of the proximity zone is configurable.

In some embodiments, when an authorized user leaves the proximity zone 108 of the workstation 102, the application state is saved by the automatic lock function. The application state of the computer at the lock condition is referred to as the “last known application state”. In some embodiments, the automatic unlock function provides an authorized user who reenters the proximity zone 108 with exactly the same application state that was available to that individual when he last left the proximity zone 108. In some embodiments, when multiple tokens are in the proximity zone of a workstation, a token selection screen is presented displaying in-range tokens.

In some embodiments, the token 106 is placed in the pocket of scrubs, business wear, or other medical and dental office worker clothing. In some embodiments, the token 106 is attached to a lanyard that is worn around the worker's 104 neck. In some embodiments, the token 106 is attached to clothing or accessories such as a belt, headwear, or scarf using a strap, loop, or other connection apparatus. In some embodiments the token 106 is held in the hand or placed in proximity to the workstation 102 while the workstation 102 is unlocked for use.

Another feature of the system and method of the present teaching is that authorized individuals with lost or stolen tokens 106 can still access the workstation 102 with traditional login procedures, such as login codes.

Another feature of the system and method of the present teaching is that it simplifies compliance with HIPAA regulations and promotes industry best practice. The authentication and authorization access control provided by the present teaching meets HIPAA regulations for protection of private patient information, avoiding government fines for non-compliance.

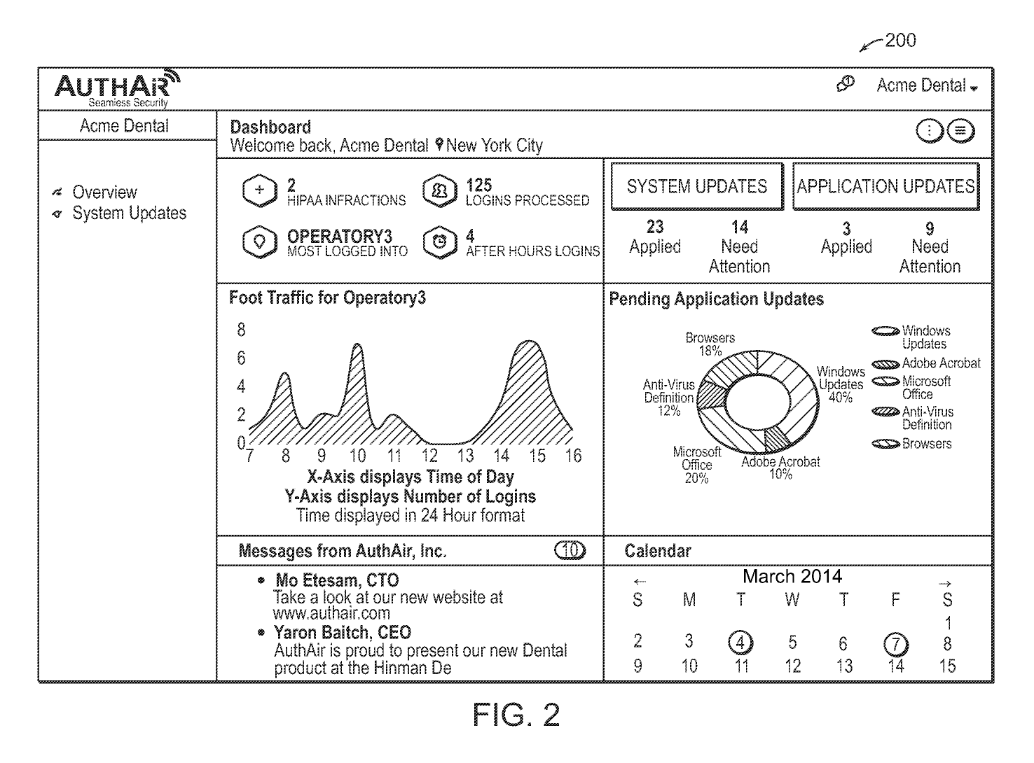

Some embodiments of the present teaching provide an audit capability. FIG. 2 illustrates a user interface 200, or dashboard, for the medical and dental office computer security system described in connection with FIGS. 1A and 1B. FIG. 2 illustrates a display of audit functions for some embodiments of the audit capability. The audit capability provides a log of machine accesses. In some embodiments, the audit capability maintains a complete record of which authorized individuals have accessed a workstation, including the times of system login, logout, unlock, and lock. The audit capability can also monitor numerous other metrics. For example, in some embodiments, the audit capability maintains a record of every unauthorized login attempt and the time. In some embodiments, the audit capability provides a record of the number of logins processed in a particular user-configurable interval. In some embodiments, the audit capability provides the number of after-hours logins. Additionally, in some embodiments, the audit capability provides the identity of the individual with the most logins, and/or the number of logins and/or logouts for each and every authorized individual. In some embodiments, the audit capability provides the number of HIPAA infractions.

In some embodiments, graphs and other visual displays of audit information are provided in addition to, or instead of, numeric representations. In some embodiments, the configuration and information provided by the audit capability is user-configurable. The audit capability may also provide, in some embodiments, all reporting information required for a medical and/or dental office's HIPAA compliance.

The system and method of the present teaching includes medical and dental office computer security system administration software. Different embodiments of the system administration software include various access control methods. In one embodiment, the access control method is a mandatory access control method, such as rule-based access control that defines specific conditions and accesses to the computer system for specific individuals. In other embodiments, the access control method is role based. With role based access control, different work functions, (e.g., system administrator, medical and dental worker, secretary) are assigned to specific roles. In other embodiments, different user types can be assigned. These roles are then provided the access appropriate to them. For example, system administrators may be provided full system software administration accesses, but no patient record access. Medical or dental workers will have access to medical or dental office software and patient records. In the role based access method, particular authorized individuals are assigned specific roles. The roles then define the access limitations and rights available to that user. The described embodiments of access control methods are exemplary and not intended to limit the teaching herein. Various other access control methods known in the art may be provided by the computer security system of the present teaching.

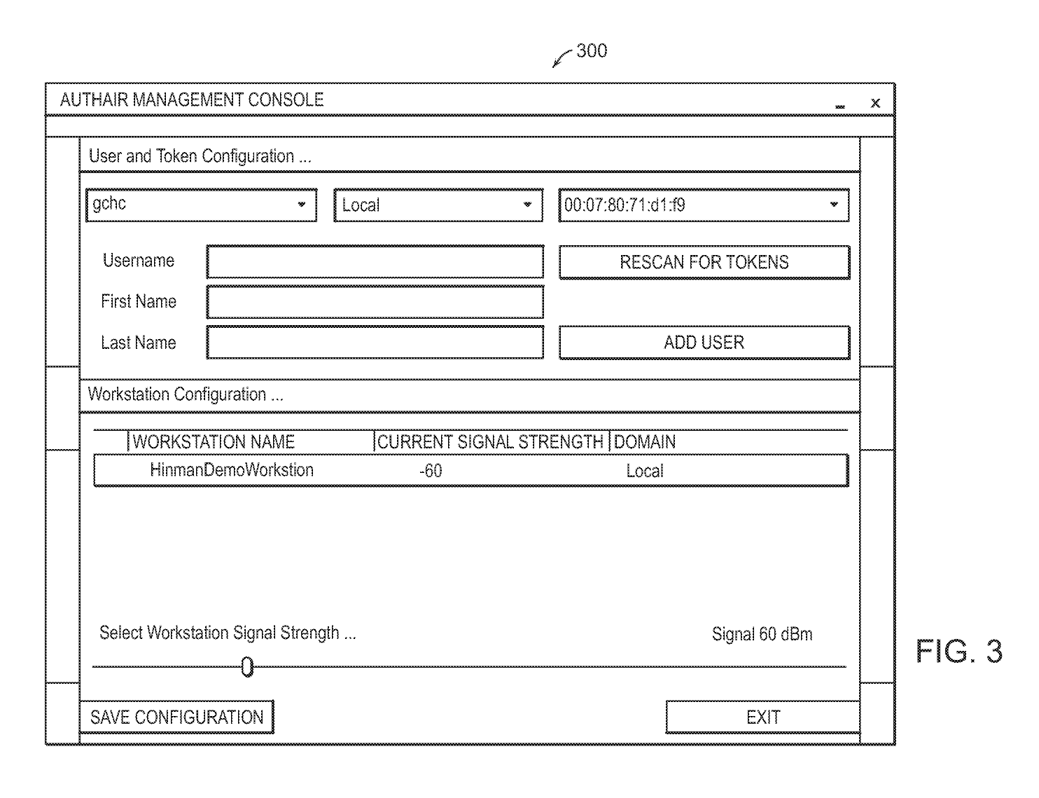

The computer security system administration software includes a user interface for inputting commands to manage the system. FIG. 3 illustrates an example computer screenshot 300 of an embodiment of a management console user interface of the present teaching. At least some of the features and functions of the system administration software may be monitored and configured using the management console user interface.

An administrative user of the system may employ the management console user interface. For purposes of this disclosure, an “administrative user” is a person or persons (e.g. information technology support personnel, business manager, etc.) responsible for changing the medical and dental office computer security system configurations, access control management, and/or managing other system administrative functions. In various embodiments, the system administration software of the medical and dental office computer security system includes the capability to add and remove authorized individuals, to uniquely identify authorized individuals, and to configure one or more workstations that are included as part of the medical and dental office computer security system.

The system administration software of some embodiments can also monitor and configure the status of the workstations 102 that are included as part of the medical and dental office computer security system 100 for features such as workstation 100 signal strength for interrogation of the tokens 106, and workstation 102 authorization domain. The system administration software of some embodiments can also monitor and configure the status of the tokens 106 that are included as part of the medical and dental office computer security system 100, configure the tokens' 106 authorization domains, and add and subtract authorized individual's tokens 106. The system administration software of some embodiments can also configure token 106 status and disable lost, stolen, or reportedly missing, tokens 106.

FIG. 3 illustrates a button on the management console user interface 300 to add an authorized individual. FIG. 3 illustrates input fields 302 on the management console user interface 300 to provide unique identifying information for an authorized individual. Referring to both FIGS. 1 and 3, FIG. 3 illustrates a button on the management console user interface 300 that scans for token hardware and checks authorization and identifying information. FIG. 3 further illustrates fields on the management console user interface 300 to monitor and configure one or more workstations 102 for a particular configuration. These example fields on the management console user interface 300 include workstation 102 domain and workstation 102 signal strength.

In some embodiments, application configurations are advertised and configured via the dashboard user interface shown in FIG. 2. This dashboard user interface may also be where the medical and dental office computer security system 100 is updated. The dashboard may include messages from the vendor regarding product features and upgrades. The dashboard may provide a variety of visual tools to assist the medical and dental office users in understanding the capability and configurations of the system.

Another feature of the medical and dental office computer security system and method of this teaching is ease of integration with existing dental office computer hardware and software. The dental office computer security system and method of this teaching is designed, in some embodiments, to operate external to the applications and other software running on the workstation operating system, including medical and dental practice management software and patient records. Application software will run substantially the same with and without the medical and dental office computer security system software installed. The medical and dental office computer security system is designed to operate with standard workstation operating system software. In some embodiments, the dental office computer security system works with workstation operating systems including Windows 7, Windows 8, and Windows 8.1.

Another feature of the medical and dental office computer security system and method of this teaching is the ability to scale and extend the system to additional and different authorized individuals, additional and different workstations, and additional and different locations, as the medical and dental practice grows and expands. The system according to the present teaching can be formed in various modules. Modules include workstation software, workstation dongle, and token hardware and firmware. Modules can be added or removed from the system as requirements for medical and dental office security and/or dental office information technology infrastructure changes. This approach simplifies expansion or changes to the system configuration. New authorized individuals are added by assigning their identity to an active token.

Each dental office computer security system module may be individually programmed and/or configured to be associated with a particular domain. This domain approach allows management of different access control implementations and/or different sites or locations. Tokens may also be removed from a domain or authorization status as the individual's authorization status changes (e.g., rescinded or suspended access, changing/adding business functions, etc.). In some embodiments, the tokens are programmed at the factory prior to shipment. In some embodiments, the wireless-enabled tokens are programmed “over the air.” Alternatively, in some embodiments, the wireless-enabled tokens are programmed at the customer premises.

Workstations may be added or removed from a domain as required by the function and placement of the particular workstation 102. In some embodiments, workstation 102 and token 106 domain management is configured via a user interface on a management console, such as that illustrated in FIG. 3. Domain reconfiguration is supported by the ability, using wireless communication, to assign master and slave assignments to computer workstations, and the ability to switch assignments by agreement.

Workstations 102 listen for tokens 106 and communicate with tokens 106 over a wireless channel. The wireless channel may be implemented using a wireless communication protocol standard, such as IEEE 802.11 or Bluetooth. The wireless communication protocols provide discovery, identification, synchronization, and other communication coordination functions for two or more devices using a common broadcast radio signal. The radio broadcast signal is non-line-of-site, and generally radiates power substantially uniformly in a spherical pattern. In various embodiments, the wireless channel is secured by standard methods of confidentiality and authentication.

In some embodiments, the workstation 102 uses an internal wireless device enabled by the dental office computer security system 100 software to communicate with the tokens 106 over the wireless channel. In some embodiments, the workstation 102 uses an external dongle with a wireless device and associated firmware to provide the wireless channel. The medical and dental office computer security system 100 software enables the dongle to communicate with and authenticate tokens 106. The workstation 102 dongle may use the workstation USB port to communicate with the workstation 102. In some embodiments, the workstation dongle has a wireless communication range of approximately 10 feet in a substantially spherical pattern centered on the dongle or internal wireless device. However, one skilled in the art will appreciate that spherical patterns do not limit the invention. The workstation dongle can include any one of a number of different types of directional antennas.

In one embodiment of the present teaching, the token resides in the proximity zone of the workstation when the signal strength of the wireless signal from the token and received by the workstation is at a predetermined value. In other embodiments, the token resides within the proximity zone of a workstation when the signal strength of the wireless signal from the token and received by the workstation is within a predetermined range. In some embodiments, the dongle or internal wireless device includes a received signal strength indicator (RSSI). RSSI indicates received signal strength in step values, typically 100 steps, from a minimum to a maximum value. The RSSI value may be used to establish the proximity zone around the workstation. In some embodiments of the dental office computer security system, RSSI is maintained within one RSSI step value of the median value to define the proximity zone.

In some embodiments, the determination that the wireless-enabled token resides in the proximity zone of a workstation is made by comparing a measured time-of-flight between the token and the workstation through the wireless channel. In some embodiments, the determination that the wireless-enabled token resides in the proximity zone of a workstation is made by comparing global positioning system (GPS) location information, or coordinates, of the token by the workstation.

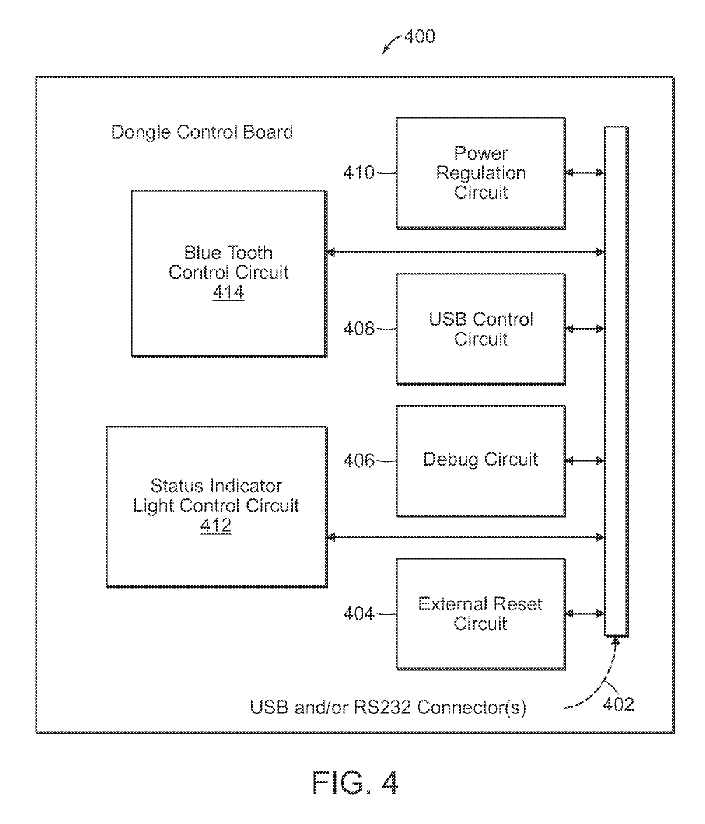

In one specific embodiment, the workstation dongle is a Bluegiga BLED112 Bluetooth Smart Dongle that uses default firmware. FIG. 4 illustrates a schematic block diagram of a board 400 for an embodiment of the medical and dental office computer security system BLE112 dongle. The BLED112 Bluetooth Smart Dongle integrates all Bluetooth Smart features such as L2CAP, ATT, GATT, GAP, and Security Manager. The BLED112 includes low-energy-operation support. The BLED 112 supports client and master mode with up to eight connections in master mode with 100 kbps+ throughput.

The board 400 includes a communications bus 402, such as a USB or serial RS232 bus, and a USB and/or serial port control circuit 408 used to connect the dongle to the workstation 102. In addition, the board 400 includes circuitry to control and monitor the BLE112 module. The board 400 includes circuitry 410 to regulate the power from a battery. The board 400 also includes reset control circuitry 404 to provide external reset capability. In addition, the board 400 includes Bluetooth control circuitry 414 and debug circuitry 406 for debugging the system. The board 400 also includes circuitry 412 to provide LED indicator lights for power and status.

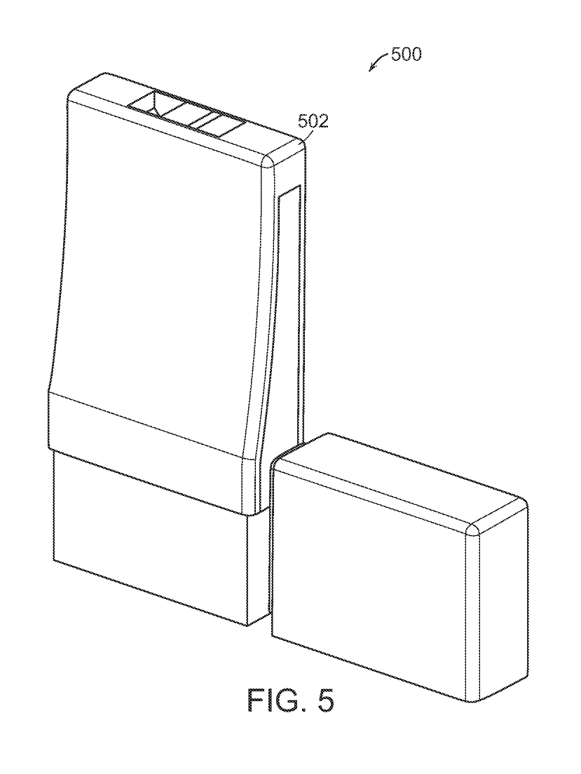

FIG. 5 illustrates an embodiment of a medical and dental office computer security system token 106. The medical and dental office computer security system tokens 106 are designed for small footprint, wearability, long battery life, and consistent operation in the medical and dental office environment. The dental office computer security system tokens 106 are designed to operate while the token 106 is in motion. Additionally, the medical and dental office computer security system tokens 106 are designed to operate at frequencies that pass through clothing, the human body, walls, furniture, and other objects typically in medical and dental offices in the path of the wireless channel. The medical and dental office computer security system tokens 106 are also designed to operate at frequencies that pass through walls, furniture, and other objects typically in such offices. In addition, in the medical and dental office computer security system, the tokens 106 are designed to operate in an electromagnetic environment with other WiFi or Bluetooth enabled devices, as well as or other 2.4 GHz wireless devices that are operational in the area where the medical and dental office computer security system is operating. The medical and dental office computer security system tokens 106 are designed to operate without interference among and between medical and dental office equipment, including electronic instrumentation and X-Ray equipment.

In some embodiments, the dental office computer security system tokens 106 have an injection molded enclosure 500 that can be sterilized using standard hard-surface sterilization techniques. FIG. 5 illustrates an embodiment of an enclosure 500 package consistent with the present teaching. In some embodiments, the enclosure 500 is printed in Polyactic acid (PLA) using a 3D printer. The enclosure 500 may include a glue-on belt clip and/or lanyard clip (not shown). The enclosure 500 is designed to have nominal impact on wireless antenna range or interference properties. The enclosure 500 is designed for easy access to change a battery 502.

In some embodiments the medical and dental office computer security system token is a BLE113, with built in over-the-air capabilities. The BLE113 is a Bluetooth Smart module for low power applications. The BLE113 includes Bluetooth radio, software stack, and GATT-based profiles (generic attribute profiles). The BLE113 Bluetooth Smart module can be powered directly from a standard 3V coin cell battery or a pair of AAA batteries, consumes 500 nA, and will wake up within a few hundred microseconds.

In some embodiments, the BLE113 has custom firmware flashed to the module for custom setting of Bluetooth features. In some embodiments, the token 106 is over-the-air programmable. In some embodiments, the token 106 is programmed at the vendor location before the initial sale. In other embodiments, the token 106 is programmed at the customer premises. In some embodiments, firmware for the tokens 106 may updated wirelessly after the medical and dental office computer security system is operational. Firmware is provided from the vendor to the customer premise and loaded onto a medical and dental office computer security management workstation. Wireless updates are initiated to tokens 106 using the system administration software running on the medical and dental office computer security management workstation.

The specifications for advertisement in Bluetooth protocol are configurable, and some settings can reduce power consumption in the token 106. Generic access profile, or GAP, commands are used to set the advertisement specifications for a particular device and to define how two Bluetooth units discover and establish a connection with each other. In some embodiments, the advertisement setting for the medical and dental office computer security tokens is set to 600=0.36 seconds, and 750=0.5625 seconds via a command such as: gap_set_adv_parameters(600,750,7). In some embodiments, the medical and dental office computer security token is set to gap_non_connectable. When a Bluetooth device is in a non-connectable state, it does not respond to paging, which serves to extend battery life. In some methods of operation, the token advertising range is set to achieve a spherical radius of about 10 feet, centered on the token.

In some embodiments of the token 106, the Bluetooth Sleeposc is enabled. Bluetooth Sleeposc is the sleep oscillator. This sleep oscillator allows the BLE113 to enter power mode 1 or 2 between Bluetooth operations or connection intervals. Thus, the maximum power mode is 2 when Sleeposc is enabled. This reduces power consumption in the token 106. In some embodiments, the token battery life is designed for a minimum of between twelve and sixteen months and will increase as new power source technology emerges.

Another aspect of the present teaching is that the token 106 is designed so as not to be easily duplicated or cloned.

Another aspect of the present teaching is that the dental office computer security system is designed to be compatible with single-sign-on solutions.

Another aspect of the present teaching is that the medical and dental office computer security system can be designed to be integrated by a medical and dental office information technology implementer. The implementer may be part of the medical and dental office practice or a third party Dental IT integrator.

### EQUIVALENTS

While the applicants' teaching is described in conjunction with various embodiments, it is not intended that the applicants' teaching be limited to such embodiments. On the contrary, the applicants' teaching encompass various alternatives, modifications, and equivalents, as will be appreciated by those of skill in the art, which may be made therein without departing from the spirit and scope of the teaching.

What is claimed is:

1. An access control system for medical and/or dental computer systems, the access control system comprising:
a) at least one computer workstation communicating with a wireless channel, the at least one computer workstation executing at least one wireless protocol that allows communication with and identification of at least one wireless-enabled token through the wireless channel and controlling a predetermined level of system access to the computer workstation for an authorized individual in possession of the token; and
b) a wireless-enabled token that uniquely identifies an authorized individual wherein the computer workstation is unlocked when the wireless-enabled token resides within a proximity zone and the computer workstation is locked when the wireless-enabled token resides outside the proximity zone.

2. The access control system of claim 1 wherein the computer workstation comprises a computer selected from the group consisting of a desktop computer, portable computer, laptop computer, handheld computer, and a wearable computer device.

3. The access control system of claim 1 wherein the computer workstation comprises a wireless device selected from the group consisting of an internal wireless device, an external wireless device, and/or a dongle wireless device.

4. The access control system of claim 1 wherein the predetermined level of system access comprises access to predetermined medical and/or dental records.

5. The access control system of claim 1 wherein the predetermined level of system access comprises access to predetermined computer applications.

6. The access control system of claim 1 wherein the predetermined level of system access comprises access to predetermined system administration functions.

7. The access control system of claim 1 wherein when the computer workstation is unlocked, the computer workstation restores to a last known application state that was used by the authorized individual in possession of the wireless-enabled token.

8. The access control system of claim 1 wherein a determination that the wireless-enabled token resides in the proximity zone is made by comparing a signal strength of the wireless-enabled token received by the workstation to a reference signal strength.

9. The access control system of claim 8 wherein the reference signal strength is within one step value of a median value return signal strength indicator (RSSI).

10. The access control system of claim 1 wherein a determination that the wireless-enabled token resides in the proximity zone is made by comparing a measured time-of-flight between the wireless-enabled token and the computer workstation to a reference time-of-flight value.

11. The access control system of claim 1 wherein a determination that the wireless-enabled token resides in the proximity zone is made by comparing a measured global positioning system coordinate of the wireless-enabled token to a global positioning system coordinate of the computer workstation.

12. The access control system of claim 1 wherein a determination that the wireless-enabled token resides in the proximity zone is made by comparing a measured global positioning system coordinate of the wireless-enabled token to a predetermined global positioning system coordinate.

13. The access control system of claim 1 wherein the at least one wireless protocol that allows communication with and identification of at least one wireless-enabled token is selected from the group consisting of IEEE Over the Air (OTA), Bluetooth, and IEEE 802.11 protocols.

14. The access control system of claim 1 wherein the wireless-enabled token comprises a secure wireless-enabled token.

15. The access control system of claim 1 wherein the wireless-enabled token comprises a key fob.

16. The access control system of claim 1 wherein the wireless-enabled token comprises a Bluetooth wireless device.

17. The access control system of claim 1 wherein the wireless-enabled token comprises a portable wireless device.

18. The access control system of claim 1 wherein the wireless-enabled token comprises a cellular telephone.

19. The access control system of claim 1 wherein the predetermined level of system access to the computer workstation for an authorized individual in possession of the token comprises role-based levels of system access that define user types.

20. The access control system of claim 1 wherein the predetermined level of system access to the computer workstation for an authorized individual in possession of the token comprises rule-based levels of system access that define predetermined levels of system access for predetermined authorized individuals.

21. The access control system of claim 1 wherein the computer workstation executes management software that configures domains.

22. The access control system of claim 1 wherein the computer workstation executes management software that configures user access.

23. The access control system of claim 1 wherein the computer workstation executes management software that disables reportedly missing wireless-enabled tokens.

24. The access control system of claim 1 wherein the computer workstation executes management software that performs audit functions.

25. The access control system of claim 24 wherein the audit functions comprise at least one of generating a log of machine accesses, generating a record of authorized individual accesses, generating a record of unauthorized access attempts, generating a record of times at which the computer workstation is locked and unlocked, and generating a record of the number of logins processed in a particular user-configurable interval.

26. The access control system of claim 24 wherein the audit functions comprise generating a record of a number of HIPAA infractions.

27. The access control system of claim 1 wherein the computer workstation executes management software that permits administrators to vary an unlock time where the predetermined level of system access to the computer workstation for an authorized individual in possession of the token is granted after the wireless-enabled token enters into the proximity zone.

28. The access control system of claim 1 wherein the computer workstation executes management software that permits administrators to vary a lock time where the predetermined level of system access to the computer workstation for an authorized individual in possession of the token is denied after the wireless-enabled token leaves the proximity zone.

29. A method of accessing medical and/or dental computer systems, the method comprising:
a) providing a computer workstation communicating with a wireless channel;
b) executing at least one wireless protocol on the computer workstation that allows communication with and identification of at least one wireless-enabled token through the wireless channel;
c) providing a wireless-enabled token that uniquely identifies an authorized individual;
d) determining if the wireless-enabled token resides within a proximity zone;
e) controlling a predetermined level of system access to the computer workstation for an authorized individual in possession of the token within the proximity zone;
f) locking the computer workstation if the wireless-enabled token is determined to not reside within a proximity zone; and
g) unlocking the computer workstation if the wireless-enabled token is determined to reside within a proximity zone.

30. The method of claim 29 wherein the predetermined level of system access comprises access to predetermined medical and/or dental records.

31. The method of claim 29 wherein the predetermined level of system access comprises access to predetermined computer applications.

32. The method of claim 29 wherein the predetermined level of system access comprises access to predetermined system administration functions.

33. The method of claim 29 wherein the unlocking the computer workstation further comprises restoring the computer workstation to a last known application state that was used by the authorized individual in possession of the wireless-enabled token.

34. The method of claim 29 further comprising determining if the wireless-enabled token resides in the proximity zone by comparing a signal strength of the wireless-enabled token received by the workstation to a reference signal strength.

35. The method of claim 29 further comprising determining if the wireless-enabled token resides in the proximity zone by determining if a predetermined signal strength is within one step value of a median value return signal strength indicator (RSSI).

36. The method of claim 29 further comprising determining if the wireless-enabled token resides in the proximity zone by comparing a measured time-of-flight between the wireless-enabled token and the computer workstation to a reference time-of-flight value.

37. The method of claim 29 further comprising determining if the wireless-enabled token resides in the proximity zone by comparing a measured global positioning system coordinate of the wireless-enabled token to a global positioning system coordinate of the computer workstation.

38. The method of claim 29 further comprising determining if the wireless-enabled token resides in the proximity zone by comparing a measured global positioning system coordinate of the wireless-enabled token to a predetermined global positioning system coordinate.

39. The method of claim 29 wherein the providing the wireless-enabled token comprises providing a secure wireless-enabled token.

40. The method of claim 29 further comprising determining the predetermined level of system access to the computer workstation by using role-based access control methods.

41. The method of claim 29 further comprising determining the predetermined level of system access to the computer workstation by using rule-based access control methods.

42. The method of claim 29 further comprising executing management software to configure domains.

43. The method of claim 29 further comprising executing management software to configure user access.

44. The method of claim 29 further comprising executing management software to configure audit functions.

45. The method of claim 29 further comprising generating a record of HIPAA infractions.

46. The method of claim 29 further comprising permitting administrators to vary an unlock time where the predetermined level of system access to the computer workstation for an authorized individual in possession of the token is granted after the wireless-enabled token enters into the proximity zone.

47. The method of claim 29 further comprising permitting administrators to vary a lock time where the predetermined level of system access to the computer workstation for an authorized individual in possession of the token is denied after the wireless-enabled token leaves the proximity zone.

48. A system for accessing medical and/or dental records, the system comprising:
a) a wireless-enabled token with access to a wireless channel; and
b) a computer workstation with access to the wireless channel, the computer workstation comprising:
i. a means for identifying the wireless-enabled token that uniquely identifies an authorized individual;
ii. a means for determining if the wireless-enabled token resides within a proximity zone;
iii. a means for locking the computer workstation if the wireless-enabled token is determined to not reside within a proximity zone; and
iv. a means for unlocking the computer workstation if the wireless-enabled token is determined to reside within a proximity zone.

49. The system of claim 48 further comprising a means for controlling a predetermined level of system access to the computer workstation for the authorized individual in possession of the wireless-enabled token within the proximity zone.
